(19) United States
(12) Patent Application Publication
(10) Pub. No.: US 2017/0148319 A1
(43) Pub. Date: May 25, 2017

(54) Traffic Hazard Alert System

(71) Applicant: Darius Reeves, Lockport, NY (US)

(72) Inventor: Darius Reeves, Lockport, NY (US)

(21) Appl. No.: 14/946,963

(22) Filed: Nov. 20, 2015

(51) Int. Cl. G08G 1/0965

(52) U.S. Cl. CPC G08G 1/0965

(57) ABSTRACT

A traffic hazard alert system includes a first vehicle that may be driven on a roadway and a transmitter is coupled to the first vehicle. A second vehicle is provided and the second vehicle may be driven on the roadway. A visual alert is coupled to the second vehicle such that the visual alert is visible. The visual alert is in communication with the transmitter. The visual alert generates a first alarm sequence to notify the second vehicle that the first vehicle is approaching. An audible alert is coupled to the second vehicle and the audible alert may be heard. The audible alert is in communication with the transmitter. The audible alert generates an second alarm sequence to notify the second vehicle that the first vehicle is approaching.

### BACKGROUND OF THE DISCLOSURE

### Field of the Disclosure

The disclosure relates to alert devices and more particularly pertains to a new alert device for alerting a passenger vehicle that an emergency vehicle is approaching.6

### SUMMARY OF THE DISCLOSURE

An embodiment of the disclosure meets the needs presented above by generally comprising a first vehicle that may be driven on a roadway and a transmitter is coupled to the first vehicle. A second vehicle is provided and the second vehicle may be driven on the roadway. A visual alert is coupled to the second vehicle such that the visual alert is visible. The visual alert is in communication with the transmitter. The visual alert generates a first alarm sequence to notify the second vehicle that the first vehicle is approaching. An audible alert is coupled to the second vehicle and the audible alert may be heard. The audible alert is in communication with the transmitter. The audible alert generates a second alarm sequence to notify the second vehicle that the first vehicle is approaching.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a traffic hazard alert system according to an embodiment of the disclosure.

FIG. 2 is a perspective view of an embodiment of the disclosure.

FIG. 3 is a perspective in-use view of an embodiment of the disclosure.

FIG. 4 is a schematic view of an embodiment of the disclosure.

FIG. 5 is a front perspective view of an alternative embodiment of the disclosure.

FIG. 6 is a perspective view of an alternative embodiment of the disclosure.

FIG. 7 is a schematic view of an alternative embodiment of the disclosure.

### DESCRIPTION OF THE PREFERRED EMBODIMENT

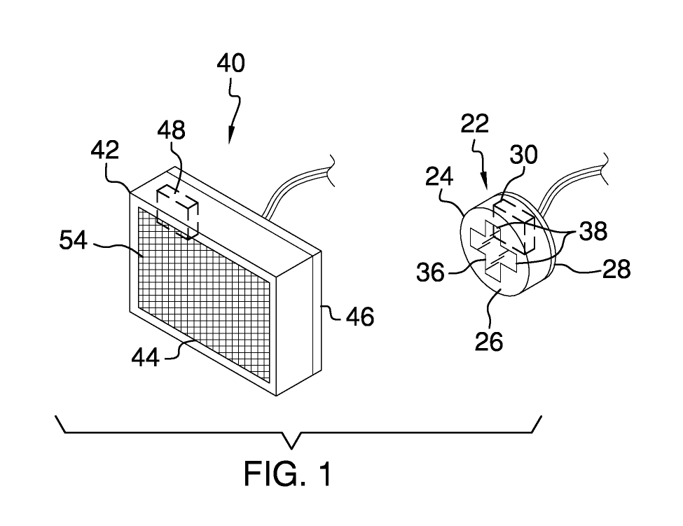

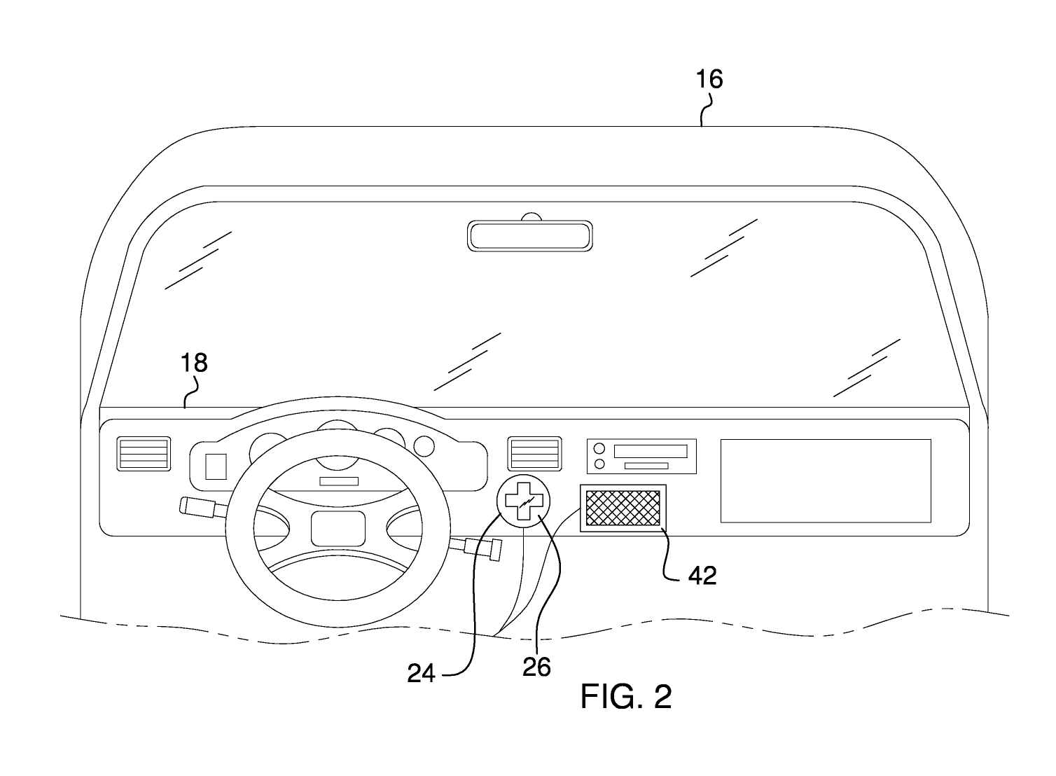

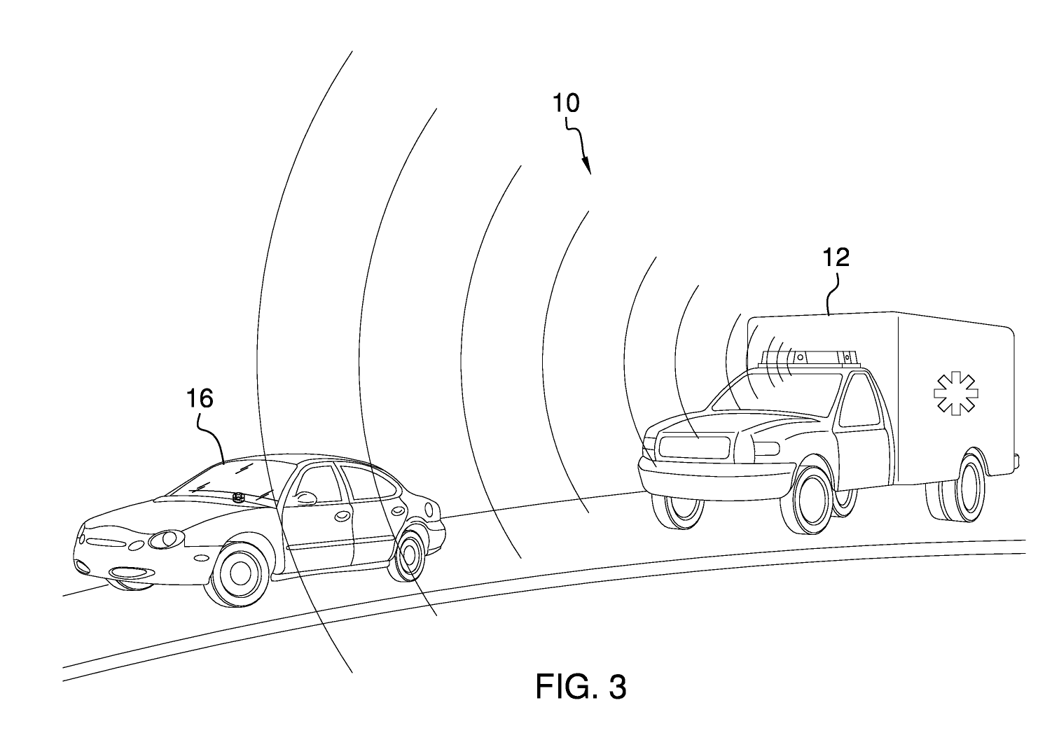

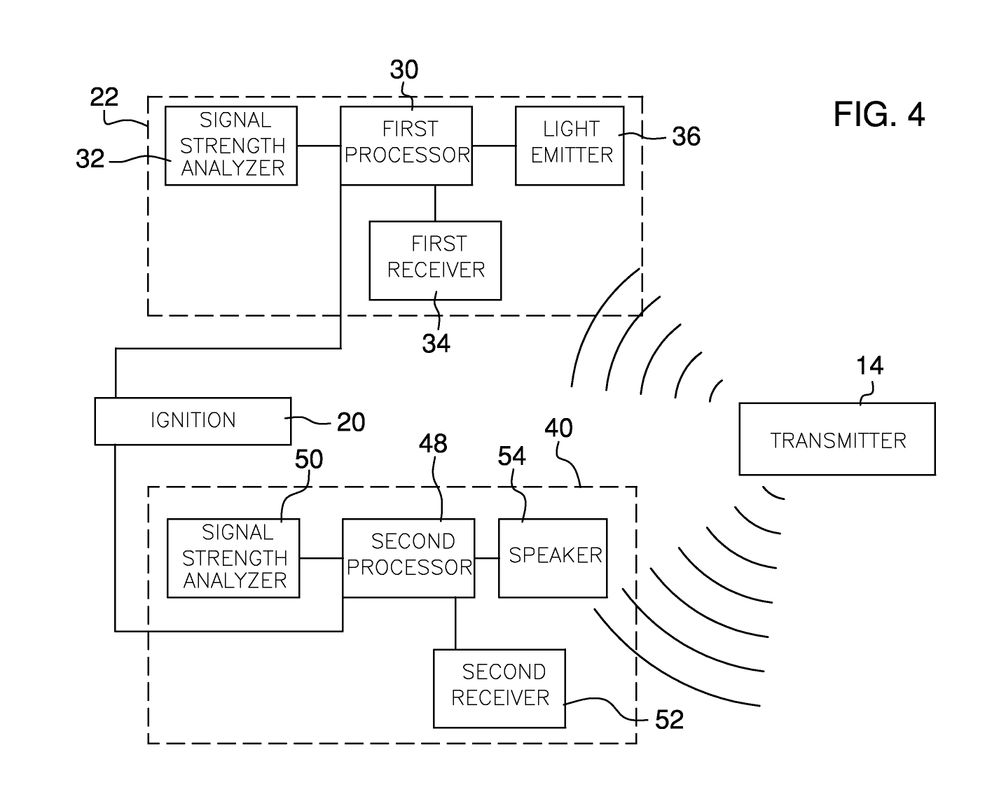

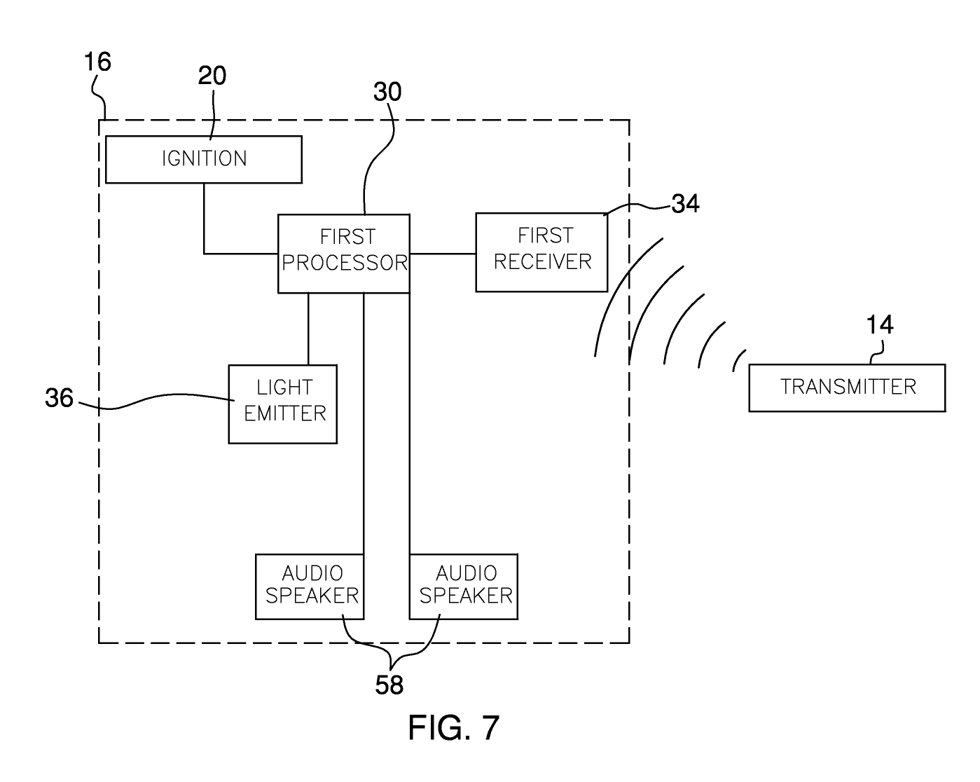

With reference now to the drawings, and in particular to FIGS. 1 through 7 thereof, a new alert device embodying the principles and concepts of an embodiment of the disclosure and generally designated by the reference numeral 10 will be described.

As best illustrated in FIGS. 1 through 7, the traffic hazard alert system 10 generally comprises a first vehicle 12 that may be driven on a roadway. The first vehicle 12 may comprise an emergency vehicle such as an ambulance or the like. A transmitter 14 is coupled to the first vehicle 12. The transmitter 14 may comprise a radio frequency transmitter or the like.

A second vehicle 16 is provided and the second vehicle 16 may be driven on the roadway. The second vehicle 16 has a dashboard 18 and an ignition 20. The second vehicle 16 may comprise a passenger vehicle or the like. A visual alert 22 is coupled to the second vehicle 16. The visual alert 22 is positioned to be visible and the visual alert 22 is in communication with the transmitter 14. The visual alert 22 generates a visual alarm. Thus, the visual alert 22 notifies the second vehicle 16 that the first vehicle 12 is approaching.

The visual alert 22 comprises a first housing 24 that has a front wall 26 and a back wall 28. The back wall 28 is coupled to the second vehicle 16 and the first housing 24 may be positioned on the dashboard 18. A first processor 30 is positioned within the first housing 24. The first processor 30 is electrically coupled to the ignition 20 and the ignition 20 turns the first processor 30 on and off. The first processor 30 includes a signal strength analyzer 32 and the first processor 30 selectively generates a first alarm sequence.

A first receiver 34 is positioned within the first housing 24 and the first receiver 34 is electrically coupled to the first processor 30. The first receiver 34 is in electrical communication with the transmitter 14. The signal strength analyzer 32 determines a distance between the first vehicle 12 and the second vehicle 16. Thus, the first processor 30 generates the first alarm sequence when the first vehicle 12 travels within a trigger distance with respect to the second vehicle 16. The first receiver 34 may comprise a radio frequency receiver or the like. The trigger distance may be a distance ranging between one hundred meters and fifteen hundred meters.

A light emitter 36 is coupled to the front wall 26 such that the light emitter 36 is visible and the light emitter 36 is electrically coupled to the first processor 30. The light emitter 36 has a pair of intersecting arms 38. Each of the intersecting arms 38 is oriented perpendicular to each other such that the light emitter 36 forms a cross associated with medical personnel. The first processor 30 turns the light emitter 36 on when the first processor 30 generates the first alarm sequence. Thus, the light emitter 36 visually communicates that the first vehicle 12 is approaching the second vehicle 16. The light emitter 36 may comprise an LED or the like.

An audible alert 40 is coupled to the second vehicle 16 and the audible alert 40 may be heard. The audible alert 40 is in communication with the transmitter 14. The audible alert 40 generates an audible alarm. Thus, the audible alert 40 may notify the second vehicle 16 that the first vehicle 12 is approaching.

The audible alert 40 comprises a second housing 42 that has a forward wall 44 and a rearward wall 46. The rearward wall 46 is coupled to the second vehicle 16 and the second housing 42 is positioned within the second vehicle 16. A second processor 48 is positioned within the second housing 42. The second processor 48 is electrically coupled to the ignition 20 and the ignition 20 turns the second processor 48 on and off. The second processor 48 includes a signal strength analyzer 50. The second processor 48 selectively generates a second alarm sequence.

A second receiver 52 is positioned within the second housing 42 and the second receiver 52 is electrically coupled to the second processor 48. The second receiver 52 is in electrical communication with the transmitter 14. Thus, the signal strength analyzer 50 corresponding to the second processor 48 determines a distance between the first vehicle 12 and the second vehicle 16. The second receiver 52 generates the second alarm sequence when the first vehicle 12 travels within the trigger distance with respect to the second vehicle 16. The second receiver 52 may comprise a radio frequency receiver or the like.

A speaker 54 is coupled to the forward wall 44 and the speaker 54 may emit an audible alarm. The speaker 54 is electrically coupled to the second processor 48. The second processor 48 turns the speaker 54 on when the second processor 48 generates the second alarm sequence. Thus, the speaker 54 audibly communicates that the first vehicle 12 is approaching the second vehicle 16.

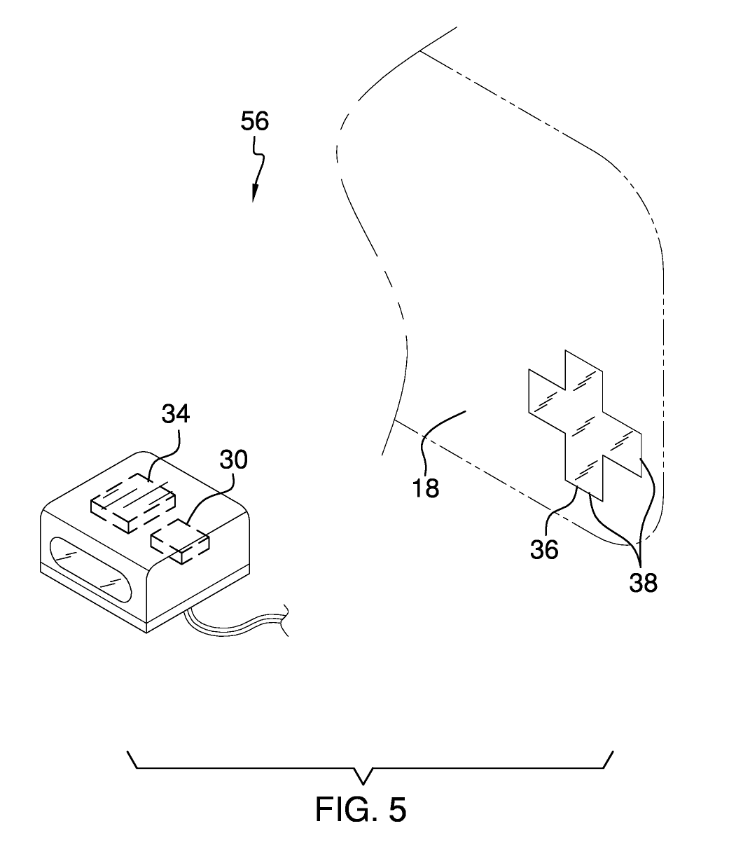

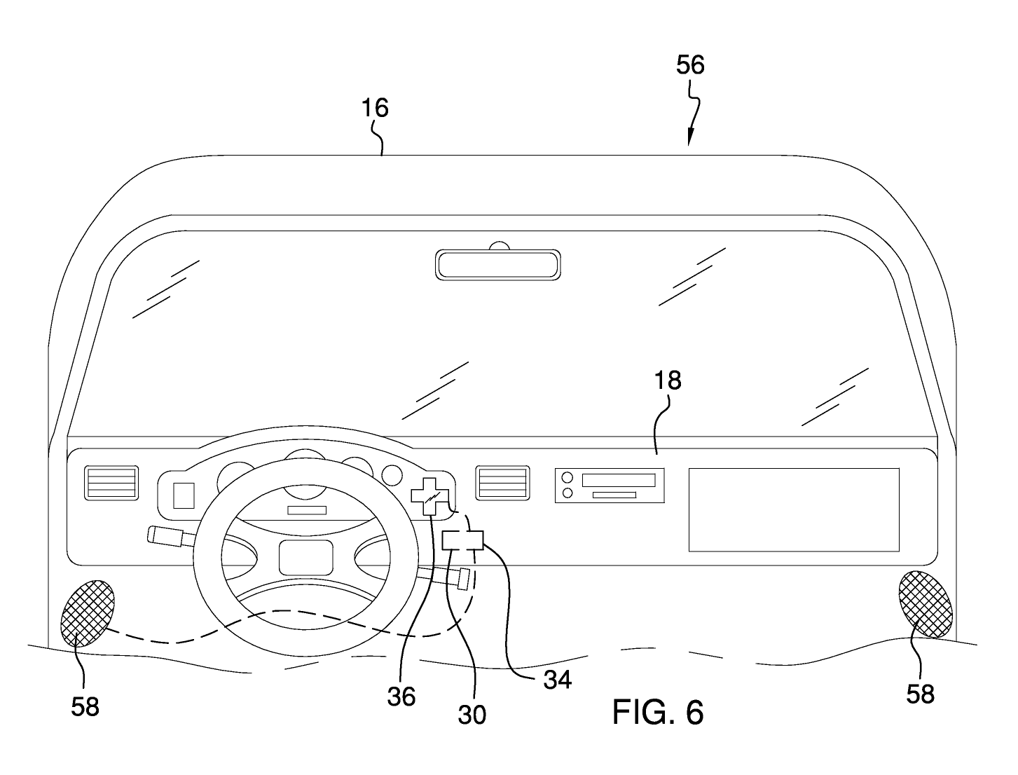

In an alternative embodiment 56 as shown in FIGS. 5 and 6, the light emitter 36 may be an integral component of the dashboard 18. The first receiver 34 and the first processor 30 may be positioned within the dashboard 18. The second vehicle 16 may have a pair of audio speakers 58 and the first processor 30 may be in electrical communication with each of the audio speakers 58. Each of the audio speakers 58 emits the audible alarm when the first processor 30 generates the first alarm sequence.

In use, each of the visual alert 22 and the audible alert 40 are turned on when the ignition 20 is turned on. The light emitter 36 emits light when the first vehicle 12 travels within the trigger distance with respect to the second vehicle 16. The speaker 54 emits the audible alarm when the first vehicle 12 travels within the trigger distance with respect to the second vehicle 16. The second vehicle 16 moves to the side of the roadway thereby facilitating the first vehicle 12 to safely pass the second vehicle 16. The visual alert 22 and the audible alert 40 gives the second vehicle 16 advance warning that the first vehicle 12 is approaching thereby enhancing traffic safety.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A traffic hazard alert system comprising:
a first vehicle being configured to be driven on a roadway;
a transmitter being coupled to said first vehicle;
a second vehicle being configured to be driven on the roadway, said second vehicle having an ignition;
a visual alert being coupled to said second vehicle wherein said visual alert is configured to be visible, said visual alert being in communication with said transmitter, said visual alert generating a first alarm sequence wherein said visual alert is configured to notify said second vehicle that said first vehicle is approaching, said visual alert comprising:
a first housing having a front wall and a back wall, said back wall being coupled to said second vehicle; and
a first processor being positioned within said first housing, said first processor being electrically coupled to said ignition such that said ignition turns said processor on and off, said first processor including a signal strength analyzer, said first processor selectively generating said first alarm sequence; and
an audible alert being coupled to said second vehicle wherein said audible alert is configured to be heard, said audible alert being in communication with said transmitter, said audible alert generating a second alarm sequence wherein said audible alert is configured to notify said second vehicle that said first vehicle is approaching.

2. (canceled)

3. The system according to claim 1, further comprising a first receiver being positioned within said first housing, said first receiver being electrically coupled to said first processor, said first receiver being in electrical communication with said transmitter such that said signal strength analyzer determines a distance between said first vehicle and said second vehicle, said first processor generating said first alarm sequence when said first vehicle travels within a trigger distance with respect to said second vehicle.

4. The system according to claim 1, further comprising a light emitter being coupled to said front wall wherein said light emitter is configured to be visible, said light emitter being electrically coupled to said first processor, said light emitter having a pair of intersecting arms, each of said intersecting arms being oriented perpendicular to each other such that said light emitter forms a cross associated with medical personnel, said first processor turning said light emitter on when said first processor generates said first alarm sequence wherein said light emitter is configured to visually communicate that said first vehicle is approaching said second vehicle.

5. The system according to claim 1, wherein:
said second vehicle has an ignition; and
said audible alert comprises:
a second housing having a forward wall and a rearward wall, said rearward wall being coupled to said first vehicle, said second housing being positioned within said second vehicle, and
a second processor being positioned within said second housing, said second processor being electrically coupled to said ignition such that said ignition turns said second processor on and off, said second processor including a signal strength analyzer, said second processor selectively generating said second alarm sequence.

6. The system according to claim 5, further comprising a second receiver being positioned within said second housing, said second receiver being electrically coupled to said second processor, said second receiver being in electrical communication with said transmitter such that said signal strength analyzer corresponding to said second processor determines a distance between said first vehicle and said second vehicle, said second receiver generating said second alarm sequence when said first vehicle travels within said trigger distance with respect to said second vehicle.

7. The system according to claim 5, further comprising a speaker being coupled to said forward wall wherein said speaker is configured to emit an audible alarm, said speaker being electrically coupled to said second processor, said second processor turning said speaker on when said second processor generates said second alarm sequence wherein said speaker is configured to audibly communicate that said first vehicle is approaching said second vehicle.

8. A traffic hazard alert system comprising:
a first vehicle being configured to be driven on a roadway;
a transmitter being coupled to said first vehicle;
a second vehicle being configured to be driven on the roadway, said second vehicle having an ignition,
a visual alert being coupled to said second vehicle wherein said visual alert is configured to be visible, said visual alert being in communication with said transmitter, said visual alert generating a first alarm sequence wherein said visual alert is configured to notify said second vehicle that said first vehicle is approaching, said visual alert comprising:
a first housing having a front wall and a back wall, said back wall being coupled to said second vehicle,
a first processor being positioned within said first housing, said first processor being electrically coupled to said ignition such that said ignition turns said processor on and off, said first processor including a signal strength analyzer, said first processor selectively generating said first alarm sequence,
a first receiver being positioned within said first housing, said first receiver being electrically coupled to said first processor, said first receiver being in electrical communication with said transmitter such that said signal strength analyzer determines a distance between said first vehicle and said second vehicle, said first processor generating said first alarm sequence when said first vehicle travels within a trigger distance with respect to said second vehicle, and
a light emitter being coupled to said front wall wherein said light emitter is configured to be visible, said light emitter being electrically coupled to said first processor, said light emitter having a pair of intersecting arms, each of said intersecting arms being oriented perpendicular to each other such that said light emitter forms a cross associated with medical personnel, said first processor turning said light emitter on when said first processor generates said first alarm sequence wherein said light emitter is configured to visually communicate that said first vehicle is approaching said second vehicle; and
an audible alert being coupled to said second vehicle wherein said audible alert is configured to be heard, said audible alert being in communication with said transmitter, said audible alert generating an second alarm sequence wherein said audible alert is configured to notify said second vehicle that said first vehicle is approaching, said audible alert comprising:
a second housing having a forward wall and a rearward wall, said rearward wall being coupled to said second vehicle, said second housing being positioned within said second vehicle,
a second processor being positioned within said second housing, said second processor being electrically coupled to said ignition such that said ignition turns said second processor on and off, said second processor including a signal strength analyzer, said second processor selectively generating said second alarm sequence,
a second receiver being positioned within said second housing, said second receiver being electrically coupled to said second processor, said second receiver being in electrical communication with said transmitter such that said signal strength analyzer corresponding to said second processor determines a distance between said first vehicle and said second vehicle, said second receiver generating said second alarm sequence when said first vehicle travels within said trigger distance with respect to said second vehicle, and
a speaker being coupled to said forward wall wherein said speaker is configured to emit an audible alarm, said speaker being electrically coupled to said second processor, said second processor turning said speaker on when said second processor generates said second alarm sequence wherein said speaker is configured to audibly communicate that said first vehicle is approaching said second vehicle.
